(19) United States
(12) Patent Application Publication
(10) Pub. No.: US 2025/0306974 A1
(43) Pub. Date: Oct. 2, 2025

(54) SCALABLE REDUNDANCY MANAGEMENT SYSTEM

(71) Applicant: MICROSOFT TECHNOLOGY LICENSING, LLC, Redmond, WA (US)

(72) Inventors: Ralph Henry Cranmer MORGAN, London (GB); Richard Jeffrey LUPTON, London (GB)

(21) Appl. No.: 18/622,779

(22) Filed: Mar. 29, 2024

(51) Int. Cl. G06F 9/455

(52) U.S. Cl. CPC G06F 9/45558; G06F 2009/45562

(57) ABSTRACT

A node of a 5G communications network, comprising: an orchestration component of an orchestrator of the 5G communications network; a processing unit; and a memory coupled to the processing unit and having instructions stored thereon, the instructions, when executed by the processing unit, causing the orchestration component to perform acts comprising: monitoring for the creation of a pair pool object; in response to detecting the creation of a pair pool object, creating a plurality of pair objects; using a pair operator, detecting creation of the pair objects; and in response to detecting the creation of one of the pair objects, instantiating a pair of stateful redundant telephony-grade nodes.

### BACKGROUND

Cloud technology serves as a potential solution to meet the demands of application providers seeking to outsource the management of hardware resources such as telecommunications hardware resources. However, considering the resources available through cloud services are used by multiple parties, cloud technology is typically not sufficient to meet the significant security and/or reliability requirements of handling application requests such as telephony application requests. Therefore, there is a need for telephony applications, including 5G telephony applications, deployed using cloud technology which are able to provide high levels of reliability and/or security.

To address these challenges, some container orchestration platforms have been developed as a tool for deploying and managing application workloads in a cloud environment, offering a way to abstract the underlying hardware and network complexities. However, many platforms lack support for advanced redundancy models, particularly scaled 1+1 redundancy.

The examples described below are not limited to implementations which solve any or all of the disadvantages of known container orchestration technology.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

Deploying stateful redundant telephony grade nodes using containerization is difficult to achieve since many orchestrators used for deploying containers assume containers are stateless. However, stateful redundancy is very important to achieve telephony grade services such as for calls to the emergency services and other types of calls.

In various examples, an orchestration component, such as in a telecommunications network node, monitors for the creation of a pair pool object. In response to detecting the creation of a pair pool object, the orchestration component creates a plurality of pair objects. Using a pair operator, the orchestration component detects creation of the pair objects; and in response to detecting the creation of one of the pair objects, instantiates a pair of stateful redundant telephony-grade nodes.

### BRIEF DESCRIPTION OF THE DRAWINGS

Embodiments of the invention will be described, by way of example, with reference to the following drawings, in which:

FIG. 1 is a schematic diagram of a container orchestration environment;

FIG. 2 is a flow diagram that outlines a systematic process involved in deploying stateful, redundant telephony-grade nodes;

FIG. 3 is a flow diagram of a method for demonstrating an example of life cycle management of telephony-grade nodes; and

FIG. 4 shows an exemplary computing-based device in which a node of a telecommunications network is implemented in some examples.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

The arrangement disclosed herein addresses a challenge in adapting an orchestrator, specifically an open-source platform for automating containerized applications' deployment, scaling, and management, such as Kubernetes, to support a specific redundancy model known as Scaled 1+1 Redundancy. It will be appreciated that Kubernetes is just one of many such platforms which may be used. Any references to Kubernetes are for example purposes only and non-limiting. Any orchestrator may be used, including but not limited to: Docker Swarm, Nomad, Redhat OpenShift, or Amazon Elastic Container Service.

Typically, such orchestrators are designed to orchestrate stateless applications and services, managing container lifecycles efficiently, performing load balancing, and ensuring the high availability of services. However, the architecture and default mechanisms of such orchestrators do not naturally accommodate the nuances of managing a pool of redundant instances that operate within a Scaled 1+1 Redundancy topology.

In a Scaled 1+1 Redundancy model, each service instance (deployed in a container) is paired with an identical instance. State has to be replicated between the containers of the pair. These pairs are then replicated across a communications network to enhance fault tolerance and ensure uninterrupted service availability. If one instance in a pair fails, the other can immediately take over, providing a seamless continuation of service. If a pair fails, another pair can take over. This model is particularly critical in environments requiring high reliability, such as telephony applications where session persistence and immediate failover capabilities are paramount.

An issue arises because some orchestrators, such as Kubernetes, treat groups of containers (i.e. the smallest deployable units, also referred to as “pods”) as largely interchangeable within a service and hence do not support the specific demands of a Scaled 1+1 Redundancy model. Such demands include simultaneous creation and management of paired instances or the intricate state synchronization between members of a pair. Such orchestrators also lack native constructs for effectively managing pools of these redundant pairs, especially in terms of scaling, monitoring, and updating them according to the logic required by this redundancy model.

The present technology addresses challenges in the realm of deploying and managing stateful, redundant telephony-grade nodes, such as Session Border Controllers (SBCs), within a container orchestration platform. The telephony-grade nodes may support IPv4/IPv6 dual-stack operation, which enables the allocation of both IPv4 and IPv6 addresses to pods and services.

In the present technology, custom operators are used within a container orchestration environment. The present technology uses custom defined objects comprising a pair pool object and a pair object. These custom defined objects enable an orchestrator to deploy telephony grade nodes with stateful redundancy in an efficient manner. A pair object inherits from pair pool objects so that a hierarchical relationship between the custom defined objects is present. This hierarchical relationship facilitates scalability of stateful redundant telephony-grade nodes as explained below.

Custom operators are specialized processes that run in their own groups (such as Kubernetes pods) from the onset of a deployment phase. They are used for extending the orchestrator's capabilities to support the requirements of stateful redundancy and scalability for telephony services. The arrangement utilizes closed-loop automation, where these operators continually monitor the state of the environment against a predefined desired state. When discrepancies arise, such as the creation of new custom-defined objects, the operators take the necessary actions to align the actual state with the intended state.

In the present technology, an operator may create what is referred to as a “pair pool object”. The pair pool object outlines the desired scale of a deployment, specifying the number of redundant pairs of nodes that should be created to meet demand. Within a pair pool is a plurality of pairs of containers, where each pair is identical except for a name or index. Upon its creation, a pair pool operator engages, recognizing this new object and subsequently generating a specified number of “pair objects”. Each of these pair objects represents a pair of stateful, redundant nodes designed to run the telephony-grade applications.

A further operator, referred to as the “pair operator”, detects these pair objects and for each, orchestrates the creation of two groups, interchangeably referred to as “pods”. These pods house the actual telephony-grade nodes. The relationship between these two operators ensures that the container orchestration platform can dynamically deploy and manage pairs of SBCs or similar functions with a high degree of reliability and scalability.

The stateful redundancy of this arrangement ensures that critical operational data, such as ongoing call information and address lookup tables, is duplicated across each pair of nodes. This duplication is vital for seamless failover capabilities, allowing one node to immediately take over the responsibilities of its counterpart in the event of a failure, thus ensuring uninterrupted service.

This arrangement also addresses the inherent limitations found in native container orchestration concepts like stateful sets, which do not sufficiently support the rapid establishment of redundancy or the creation of a pool of such sets. By leveraging custom resource definitions (CRDs) for both the pair pool and pair objects, the system achieves a level of flexibility and efficiency not readily available with out-of-the-box solutions. This allows for the deployment of multiple pools of redundant pairs, each capable of performing different functions, thereby offering a nuanced approach to scaling and redundancy management for complex telephony systems.

In various examples, an orchestration component, such as in a telecommunications network node, monitors for the creation of a pair pool object. The pair pool object may be created in a database accessible to the orchestration component and may be created by a human engineer or by an automated process. The database may be distributed. A pair pool object comprises software created by completing fields in a schema such as a custom resource definition.

In response to detecting the creation of a pair pool object in the database accessible to the orchestration component, the orchestration component creates a plurality of pair objects in the database. The pair objects inherit from or are chained to the pair pool object, since the pair objects are part of the pair pool. A pair object comprises software created by completing fields in a schema. A pair object comprises software that enables state to be replicated between two containers that form a pair. Using a pair operator, the orchestration component detects creation of the pair objects; and in response to detecting the creation of one of the pair objects, instantiates a pair of stateful redundant telephony-grade nodes. In this way many pairs of stateful redundant telephony grade nodes are efficiently deployed, such that the pairs of nodes are in a pair pool i.e. are identical barring an index. It is possible to have more than one pair pool where each pair pool has a different function, such as one for signaling and one for media.

The inventors have recognized that using a stateful set puts constraints on groups of containers, or pods, which are incompatible with 1+1 redundancy. Using stateful sets is problematic because pods or groups are not created at the same time so that redundancy is not achieved quickly.

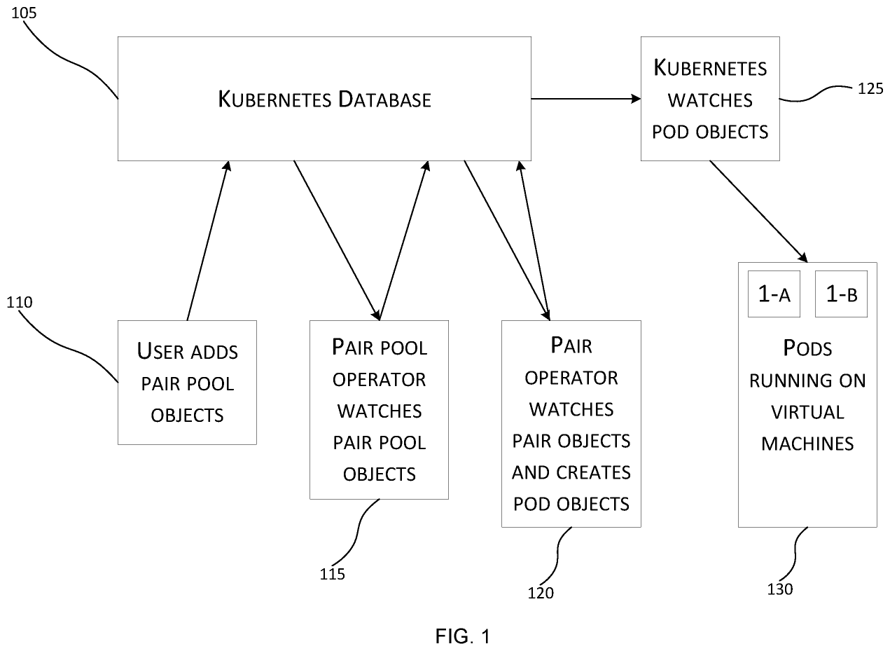

There is shown in FIG. 1 a schematic diagram of a container orchestration environment. In this example, the arrangement is shown using a Kubernetes platform, but other platforms may be used (an orchestrator is an example of a platform). The first step of this exemplary arrangement involves a user or administrator defining and inputting pair pool objects into a database used by the orchestrator in step 110. Pair pool objects specify a desired configuration for deploying redundant pairs of telephony-grade nodes, serving as instructions for how many pairs of stateful, redundant nodes are required for the application's performance.

A Kubernetes database 105 serves as a central repository within the container orchestration system, storing the state and configuration of all orchestration objects, including custom objects like pair pool objects and pod objects. The database ensures the persistence of system state and configurations, facilitating the orchestration system's ability to manage, scale, and recover applications deployed within its environment.

A custom operator within the container orchestration environment, the pair pool operator 115 is designed to monitor the Kubernetes database for the creation or modification of pair pool objects. Upon detecting new or updated pair pool objects, the operator initiates actions to fulfill the specified requirements, such as creating the appropriate number of pair objects that correspond to the desired number of redundant node pairs.

After generating pair objects based on the specifications within the pair pool objects, the pair operator proceeds to monitor these pair objects in step 120. For each pair object, the operator creates pod objects, which represent the actual deployable units within the container orchestration environment. These pod objects contain the necessary configurations to instantiate SBCs, or other telecommunications network functions, as pods running within a communications network.

Step 125 involves the container orchestration system's core functionality, where it continuously monitors the Kubernetes database for pod objects. Upon detecting new or updated pod objects, the system automatically orchestrates the deployment of these pods onto the appropriate virtual machines or physical hardware, ensuring that the application's components are correctly instantiated and managed according to their defined specifications.

The final stage in the workflow sees the pods, which encapsulate the telephony-grade applications, deployed and running on virtual machines within the communications network 130. These virtual machines, labeled for illustration as machines 1A and 1B, host the pods and provide the computational resources necessary for their operation. The deployment ensures that each pair of nodes operates in a stateful, redundant manner, enabling high availability and reliability of the telephony-grade services by allowing one node to seamlessly take over the functions of its pair in the event of a failure.

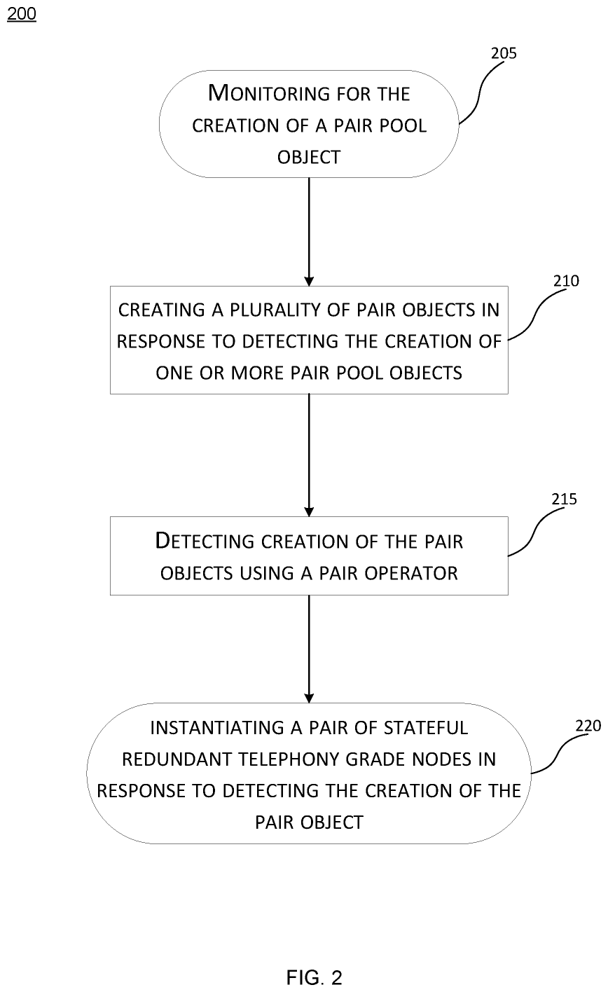

FIG. 2 presents a flow chart (200) that outlines the systematic process involved in deploying stateful, redundant telephony-grade nodes within a communications network using container orchestration. The process begins with the step of monitoring for the creation of a pair pool object 205. This initial phase involves the continuous observation of the orchestration environment for any new or updated pair pool objects. These objects dictate the desired configuration and scaling requirements for deploying redundant pairs of telephony-grade nodes. The monitoring is conducted by a custom operator, specifically designed to react to changes in the pair pool object's state within the orchestration environment.

Upon detecting the creation of one or more pair pool objects in step 210, the system transitions to the next phase. In this stage, the operator responsible for monitoring pair pool objects proceeds to create a corresponding number of pair objects based on the specifications detailed in the detected pair pool objects. These pair objects comprise the necessary information to guide their instantiation and configuration.

The next step 215 is the detection of the creation of pair objects using a pair operator. This step shows the role of another custom operator, the pair operator, which specializes in monitoring the orchestration environment for the presence of newly created pair objects. The detection of these pair objects triggers the pair operator to take further action, moving the deployment process into its subsequent phase.

The final step 220 illustrated in the flow chart 200 is the instantiation of a pair of stateful redundant telephony grade nodes in response to detecting the creation of the pair object. This phase comprises deploying the nodes that will run the telephony-grade applications in a highly available and redundant manner. Upon detecting the pair objects, the pair operator orchestrates the deployment of pods that instantiate the specified pairs of nodes in the communications network. These nodes are designed to operate in tandem, ensuring uninterrupted service by maintaining a replicated state that allows for seamless failover in case one node encounters a failure.

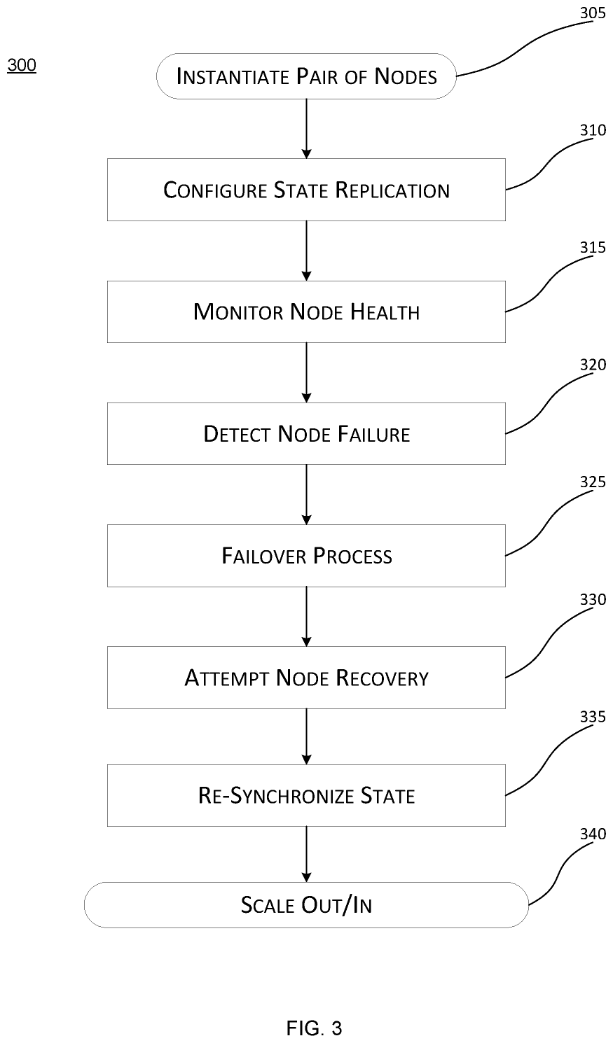

FIG. 3 shows a flow chart 300 demonstrating an example of life cycle management of the telephony-grade nodes, and include the following steps:

A pair of stateful, redundant telephony-grade nodes is created in step 305. The nodes are set up in step 310 to replicate their state (such as call data and routing information) between each other. The health and status of each node in the pair is continuously checked in step 315. In this example, step 320 detects that the arrangement comprises one node in the pair that has failed or become unresponsive.

In such a case, the responsibilities of the failed node are automatically transferred in step 325 to its corresponding pair node, also referred to as the “redundant node”, leveraging the replicated state to ensure continuity. An attempt may be made in step 330 to recover the performance of the node, optionally trying to recover or restart the failed node. Once the failed node is recovered, step 335 synchronizes the state between the pair to ensure both nodes are up to date.

Based on demand or operational requirements, the number of pairs may be dynamically adjusted in step 340 by either adding more pairs for increased capacity or reducing them to conserve resources. This allows the system to dynamically adjust to varying load conditions while maintaining the appearance of a single SBC entity to external systems.

Extending an orchestrator to include pair pool objects and pair objects enables an orchestrator to operate in an unconventional manner to achieve creation of stateful redundant telephony grade nodes of a communications network.

Enabling an orchestrator to instantiate stateful redundant telephony grade nodes in a communications network improves the functioning of the underlying communications network.

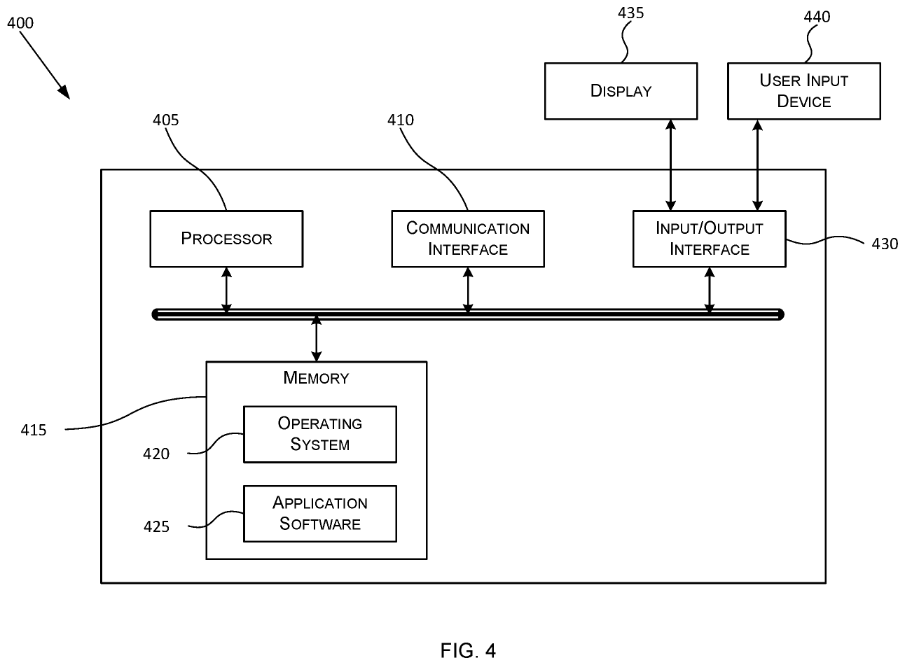

FIG. 4 illustrates various components of an exemplary computing-based device 400 which may be implemented as any form of a computing and/or electronic device, and in which groups of containers and/or an orchestrator may be implemented as part of a telecommunications network.

Computing-based device 400 comprises one or more processors 405 which may be microprocessors, controllers or any other suitable type of processors for processing computer executable instructions to control the operation of the device. In some examples, for example where a system on a chip architecture is used, the processors 405 may include one or more fixed function blocks (also referred to as accelerators) which implement a part of the method in hardware (rather than software or firmware). Platform software comprising an operating system 420 or any other suitable platform software may be provided at the computing-based device to enable application software 425 to be executed on the device. Memory 415 may store one or more groups of containers.

The computer executable instructions may be provided using any computer-readable media that is accessible by computing based device 400. Computer-readable media may include, for example, computer storage media such as memory 415 and communications media. Computer storage media, such as memory 415, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media is shown within the computing-based device 400 it will be appreciated that the storage may be distributed or located remotely and accessed via a network or other communication link (e.g. using communication interface 410). The computing-based device 400 may be a node of a telecommunications network connected to other nodes via communication interface 410.

The computing-based device 400 also comprises an input/output interface 430 arranged to optionally output display information to a display device 435 which may be separate from or integral to the computing-based device 400. The display information may provide a graphical user interface with information about groups of containers, stateful redundant nodes, pool objects and other information. The input/output interface 430 is also arranged to receive and process input from one or more devices, such as a user input device 440 (e.g. a mouse or a keyboard). In one example the display device 435 may also act as the user input device 440 if it is a touch sensitive display device.

The term “computer” is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Alternatively or in addition to the other examples described herein, examples include any combination of the following clauses:

Clause A. A computer-implemented method performed by an orchestration component, the method comprising the steps of:
monitoring for the creation of a pair pool object;
   in response to detecting the creation of a pair pool object, creating a plurality of pair objects;
   using a pair operator, detecting creation of the pair objects; and
in response to detecting the creation of one of the pair objects, instantiating a pair of stateful redundant telephony-grade nodes.

Clause B The method of clause A, wherein the orchestration component is a custom Kubernetes operator.

Clause C The method of any preceding clause, wherein the pair pool object specifies a number of pair objects to be created by the pair pool operator.

Clause D The method of any preceding clause, wherein the pair operator is responsible for creating two containers for each pair object, each container representing a node within the pair.

Clause E The method of any preceding clause, wherein each pair object represents a highly available pair of stateful redundant telephony-grade nodes within the orchestration component.

Clause F The method of any preceding clause, wherein the detection of pair pool objects by the orchestration component is performed using closed loop automation.

Clause G The method of clause F, wherein closed loop automation comprises continuous monitoring by the orchestration component for objects of relevant types.

Clause H The method of any preceding clause, wherein the pair pool object includes configuration data specifying a container image to be used for the telephony-grade nodes.

Clause I The method of any preceding clause, wherein each telephony-grade node is instantiated within its own dedicated group of containers.

Clause J The method of clause I, wherein the dedicated group of containers is contained within one or more Kubernetes pods. A pod is a unit that an orchestrator creates (all the containers in a pod are effectively parts of the pod—they cannot be created or destroyed independently of the pod, although they can be restarted independently of the pod).

Clause K The method of clause J, wherein the dedicated group of containers are configured with resource limits.

Clause L The method of any preceding clause, wherein upon failure of one of the pair of stateful redundant telephony-grade nodes, the other node automatically assumes the role of the failed node. In an example, the surviving member of a pair unilaterally takes over when it realizes the other member of the pair has failed (there are heartbeats between the two members of a pair). An orchestrator itself may monitor the health of the containers within a pod and restarts them if they aren't healthy. That aids in recovery of a failed pod.

Clause M The method of any preceding clause, further including the step of:
dynamically scaling the number of pairs in the pair pool according to real-time workload metrics.

Clause N The method of clause M, wherein the one or more real-time workload metrics comprise one or more of: central processing unit (CPU) utilization, memory usage, or network throughput of the telephony-grade nodes.

Clause O The method of clause N, wherein capacity scaling is achieved by managing multiple pairs of telephony-grade nodes.

Clause P The method of any preceding clause, wherein orchestration component is operable to perform one or more of the following operations: creation, deletion, scaling, and/or failover of the telephony-grade nodes.

Clause Q The method of any preceding clause, wherein the method is implemented within a cloud-native environment supporting multi-cloud or hybrid cloud deployment.

Clause R The method of any preceding clause, wherein the telephony-grade nodes support IPv4/IPv6 dual-stack operation

Clause S An orchestration component of a communications network node, comprising:
a processing unit; and
a memory coupled to the processing unit and having instructions stored thereon, the instructions, when executed by the processing unit, causing the device to perform acts comprising:
monitoring for the creation of a pair pool object;
   in response to detecting the creation of a pair pool object, creating a plurality of pair objects;
   using a pair operator, detecting creation of the pair objects; and
in response to detecting the creation of one of the pair objects, instantiating a pair of stateful redundant telephony-grade nodes.

Clause T A node of a 5G communications network, comprising:
an orchestration component of an orchestrator of the 5G communications network;
a processing unit; and
a memory coupled to the processing unit and having instructions stored thereon, the instructions, when executed by the processing unit, causing the orchestration component to perform acts comprising:
monitoring for the creation of a pair pool object;
   in response to detecting the creation of a pair pool object, creating a plurality of pair objects;
   using a pair operator, detecting creation of the pair objects; and
in response to detecting the creation of one of the pair objects, instantiating a pair of stateful redundant telephony-grade nodes.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term “comprising” is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various examples have been described above with a certain degree of particularity, or with reference to one or more individual embodiments, those skilled in the art could make numerous alterations to the disclosed embodiments without departing from the scope of this specification.

1. A computer-implemented method performed by an orchestration component, the method comprising:
monitoring for creation of a pair pool object;
in response to detecting the creation of a pair pool object, creating a plurality of pair objects;
using a pair operator, detecting creation of the pair objects; and
in response to detecting the creation of one of the pair objects, instantiating a pair of stateful redundant telephony-grade nodes.

2. The method of claim 1, wherein the orchestration component is a custom Kubernetes operator.

3. The method of claim 1, wherein the pair pool object specifies a number of pair objects to be created.

4. The method of claim 1, wherein the pair operator is responsible for creating two containers for each pair object, each container representing a node within the pair.

5. The method of claim 1, wherein each pair object represents a highly available pair of stateful redundant telephony-grade nodes within the orchestration component.

6. The method of claim 1, wherein the detection of pair pool objects by the orchestration component is performed using closed loop automation.

7. The method of claim 6, wherein closed loop automation comprises continuous monitoring by the orchestration component for objects of relevant types.

8. The method of claim 1, wherein the pair pool object includes configuration data specifying a container image to be used for the telephony-grade nodes.

9. The method of claim 1, wherein each telephony-grade node is instantiated within its own dedicated group of containers.

10. The method of claim 9, wherein the dedicated group of containers is contained within one or more Kubernetes pods.

11. The method of claim 10, wherein the dedicated group of containers are configured with resource limits.

12. The method of claim 1, wherein upon failure of one of the pair of stateful redundant telephony-grade nodes, the other node automatically assumes a role of the failed node.

13. The method of claim 1, further comprising:
dynamically scaling a number of pairs in the pair pool according to real-time workload metrics.

14. The method of claim 13, wherein the real-time workload metrics comprise one or more of: central processing unit (CPU) utilization, memory usage, or network throughput of the telephony-grade nodes.

15. The method of claim 14, wherein capacity scaling is achieved by managing multiple pairs of telephony-grade nodes.

16. The method of claim 1, wherein orchestration component is operable to perform one or more of the following operations: creation, deletion, scaling, and/or failover of the telephony-grade nodes.

17. The method of claim 1, wherein the method is implemented within a cloud-native environment supporting multi-cloud or hybrid cloud deployment.

18. The method of claim 1, wherein the telephony-grade nodes support IPv4/IPv6 dual-stack operation.

19. A communications network node implementing an orchestration component, the communications network node comprising:
a processing unit; and
a memory coupled to the processing unit and having instructions stored thereon, the instructions, when executed by the processing unit, causing the communications network node to perform operations comprising:
monitoring for creation of a pair pool object;
in response to detecting the creation of a pair pool object, creating a plurality of pair objects;
using a pair operator, detecting creation of the pair objects; and
in response to detecting the creation of one of the pair objects, instantiating a pair of stateful redundant telephony-grade nodes.

20. A node of a 5G communications network, comprising:
an orchestration component of an orchestrator of the 5G communications network;
a processing unit; and
a memory coupled to the processing unit and having instructions stored thereon, the instructions, when executed by the processing unit, causing the orchestration component to perform acts comprising:
monitoring for creation of a pair pool object;
in response to detecting the creation of a pair pool object, creating a plurality of pair objects;
using a pair operator, detecting creation of the pair objects; and
in response to detecting the creation of one of the pair objects, instantiating a pair of stateful redundant telephony-grade nodes.
